(19) United States
(12) Patent Application Publication
(10) Pub. No.: US 2018/0065471 A1
(43) Pub. Date: Mar. 8, 2018

(54) MOUNTING DEVICE FOR COOLING MODULE OF VEHICLE

(71) Applicants: Hyundai Motor Company, Seoul (KR); Kia Motors Corporation, Seoul (KR); Hanon Systems, Daejeon (KR)

(72) Inventors: Hyeonkeun YUN, Hwaseong-si (KR); Dae Young KIM, Anyang-si (KR); Sung Wook PARK, Daejeon (KR); Ok Ryul MIN, Daejeon (KR)

(73) Assignees: Hyundai Motor Company, Seoul (KR); Kia Motors Corporation, Seoul (KR); Hanon Systems, Daejeon (KR)

(21) Appl. No.: 15/383,872

(22) Filed: Dec. 19, 2016

(30) Foreign Application Priority Data
Sep. 6, 2016 (KR) 10-2016-0114212

(51) Int. Cl. B60K 11/04

(52) U.S. Cl. CPC B60K 11/04

(57) ABSTRACT

A mounting device for a cooling module of the vehicle, serving to install a cooling module of the vehicle to a front end module (FEM), may include a mounting bracket and having a fastening portion provided in a lower portion thereof, an assembling portion provided in an upper portion thereof, and having a bushing installation opening provided therein, a vibration-proof bushing having an inside member and an outside member connected by a plurality of bridges and mounted in the bushing installation opening, and an adapter having flanges provided on inner and outer portions thereof, having a second end portion inserted between a mounting pin formed in a mounting portion of the cooling module and a central opening of the vibration-proof bushing into which the mounting pin is inserted, and fixing the vibration-proof bushing to the mounting pin through the flanges.

### CROSS-REFERENCE TO RELATED APPLICATION

The present application claims priority to Korean Patent Application No. 10-2016-0114212 filed on Sep. 6, 2016, the entire contents of which is incorporated herein for all purposes by this reference.

### BACKGROUND OF THE INVENTION

### Field of the Invention

The present invention relates to a mounting for a cooling module of a vehicle and, more particularly, to a mounting device for a cooling module of a vehicle, capable of preventing generation of coupling in connecting a cooling module and a front end module.

### Description of Related Art

In general, a cooling module installed on a front side of a vehicle includes condenser condensing a refrigerant of an air-conditioner system, a radiator supplying a cooled coolant to an engine, a separate sub-radiator cooling an intercooler or an electric/electronic component, and a cooling fan installed on a rear side with respect to a forward/backward direction of the vehicle.

The cooling module configured in this manner is installed in a front end module provided on a front side of the vehicle through a cooling module mounting unit and fixed to a vehicle body.

Here, the related art cooling module mounting unit is mounted on both sides of an upper portion of the front end module in a width direction or both sides of upper and lower portions thereof to enable the cooling module to be mounted in the front end module.

The cooling module mounting unit is provided integrally together with an insulator, and absorbs vibration and noise generated by an engine and transmitted to the cooling module through the insulator to prevent transmission of vibration and noise to the vehicle body.

However, in a case in which the vehicle quickly turns, the cooling module, together with the cooling module mounting unit, is tilted in the center of gravity in the opposite direction of a turning direction of the vehicle, degrading turning stability of the vehicle overall.

Also, the horizontal tilting phenomenon of the cooling module degrades durability of the insulator and generates coupling from the cooling module mounting unit, degrading noise, vibration, harshness (NVH) performance of the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a mounting for a cooling module of a vehicle, which connects opposite sides of a cooling module to a front end module and is designed such that a vibration-proof bushing is compressed to a mounting part of the cooling module, when assembled, thus preventing generation of coupling due to tolerance.

Various aspects of the present invention are directed to providing a mounting device for a cooling module of a vehicle, serving to install a cooling module of a vehicle to a front end module (FEM), including: a mounting bracket having a fastening part provided in a lower portion thereof, an assembling part provided in an upper portion thereof, and having a bushing installation hole provided therein; a vibration-proof bushing having an inside member and an outside member connected by a plurality of bridges and mounted in the bushing installation hole; and an adapter having flanges provided on inner and outer portions thereof, having the other end portion inserted between a mounting pin formed in a mounting part of the cooling module and a central hole of the vibration-proof bushing into which the mounting pin is inserted, and fixing the vibration-proof bushing to the mounting pin through the flanges.

A rib may be provided on an inside circumferential surface of the bushing installation hole of the mounting bracket to set a position of the vibration-proof bushing.

The mounting bracket, in a state of being inserted into a fastening recess of the FEM, may be fastened to the fastening recess of the FEM by a bolt through the assembling part, to be mounted in the FEM.

A planar section may be provided in a portion of the inside circumferential surface of the bushing installation hole.

An outer circumferential surface of the outside member may be bonded to the bushing installation hole, the inside member may be disposed on an inside of the outside member and connected to the outside member through the plurality of bridges, and one end portion of the inside member corresponding to the mounting part may protrude in an axial direction, relative to the outside member.

When the adapter is fastened, the protruded one end portion of the inside member of the vibration-proof bushing may be compressed to the mounting part.

The adapter may be provided as a quadrangular tubular member and include an outer flange provided on a front end portion thereof outwardly and an inner flange provided on the front end portion inwardly.

The adapter may support the inside member through the outer flange and may be fastened by a bolt, in a state of being in contact with a front end portion of the mounting pin through the inner flange.

Corner portions of the adapter may be rounded. The mounting bracket and the adapter may be formed of plastic. According to an exemplary embodiment of the present invention, since the mounting device for a cooling module of a vehicle connects both sides of the cooling module to the FEM and is designed in an overlapping manner such that the vibration-proof bushing is compressed to the mounting part of the cooling module, when assembled, whereby generation of coupling due to tolerance may be prevented.

Also, the mounting device may enhance vibration insulation performance and mounting performance of the cooling module through the vibration-proof bushing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a front side of a vehicle body to which a mounting device for a cooling module of a vehicle according to an exemplary embodiment of the present invention is applied.

FIG. 2 is a perspective view of a mounting device for a cooling module of a vehicle according to an exemplary embodiment of the present invention.

FIG. 3 is an exploded perspective view of a mounting device for a cooling module of a vehicle according to an exemplary embodiment of the present invention.

FIG. 4 is a front view illustrating installation of a mounting device for a cooling module of a according to an exemplary embodiment of the present invention.

FIG. 5 is a cross-sectional view taken along line A-A of FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

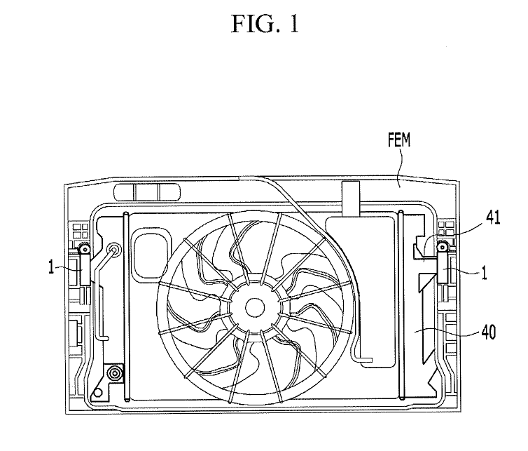

FIG. 1 is a view illustrating a front side of a vehicle body to which a mounting device for a cooling module of a vehicle according to an exemplary embodiment of the present invention is applied.

Referring to FIG. 1, a mounting device 1 for a cooling module of a vehicle (hereinafter, referred to as a “mounting unit”) according to an exemplary embodiment of the present invention is applied to install a cooling module 40 in a front end module (FEM) mounted on a front side of a vehicle.

The mounting device 1 is mounted on opposite sides of the cooling module 40 and stably fixes the cooling module 40 to the FEM.

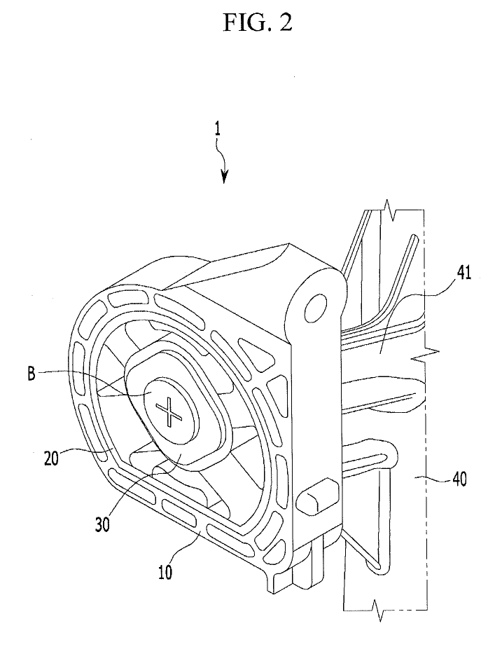

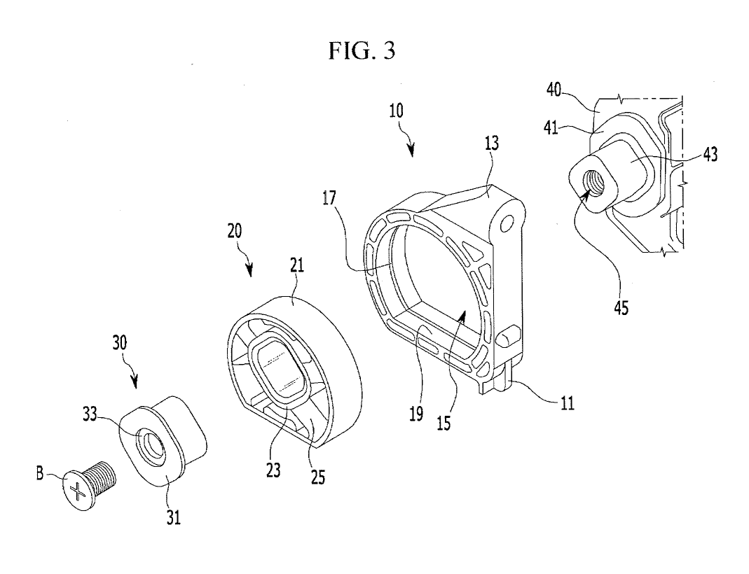

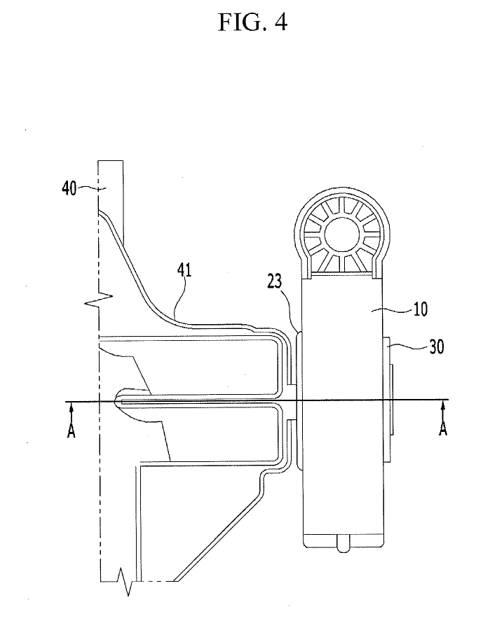

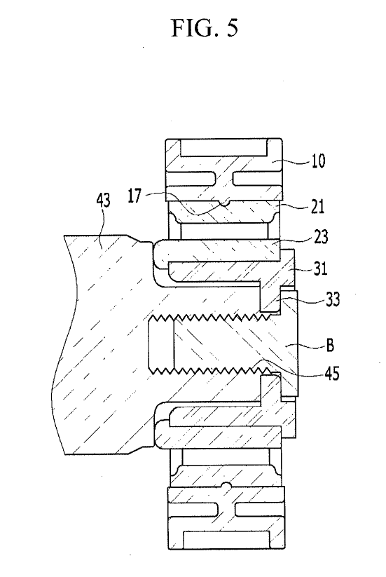

FIG. 2 is a perspective view of a mounting device for a cooling module of a vehicle according to an exemplary embodiment of the present invention, FIG. 3 is an exploded perspective view of a mounting device for a cooling module of a vehicle according to an exemplary embodiment of the present invention, FIG. 4 is a front view illustrating installation of a mounting device for a cooling module of a according to an exemplary embodiment of the present invention, and FIG. 5 is a cross-sectional view taken along line A-A of FIG. 4.

Referring to FIGS. 2 to 5, the mounting device 1 includes a mounting bracket 10, a vibration-proof bushing 20, and an adapter 30.

A fastening part 11 is formed in a lower portion of the mounting bracket 10, and an assembling part 13 is formed in an upper portion of the mounting bracket 10.

The mounting bracket 10, in a state of being inserted into a fastening recess of the FEM, is fastened to the fastening recess of the FEM by a bolt through the assembling part 13, to be mounted in the FEM.

A bushing installation hole 15 is formed within the mounting bracket 10.

Here, in the mounting bracket 10, a rib 17 is formed on an inside circumferential surface of the bushing installation hole 15 and protrudes toward the center of the bushing installation hole 15 to set a position of the vibration-proof bushing 20.

Also, a planar section 19 is provided in a portion of the inside circumferential surface of the bushing installation hole 15.

The planar section 19 serves to prevent rotation of the vibration-proof bushing 20 inserted into the bushing installation hole 15.

In an exemplary embodiment of the present invention, it is described that the planar section 19 is provided below the bushing installation hole 15, but the present invention is not limited thereto and a position of the planar section 19 may be varied to be applied.

The mounting bracket 10 may be formed of plastic.

The vibration-proof bushing 20 includes an outside member 21 and an inside member 23 and is mounted in the bushing installation hole 15.

The outside member 21 and the inside member 23 are connected by a plurality of bridges 25.

That is, an outer circumferential surface of the outside member 21 is bonded to the bushing installation hole 15. The inside member 23 is disposed on an inside of the outside member 21 and connected to the outside member 21 through the plurality of bridges 25.

One end portion of the inside member 23 corresponding to the mounting part 41 may protrude in an axial direction, relative to the outside member 21.

When the adapter 30 is fastened to the vibration-proof bushing 20 configured as described above, the protruded one end portion of the inside member 23 is compressed to the mounting part 41.

The adapter 30 is inserted between a mounting pin 43 formed on the mounting part 41 and a central hole of the vibration-proof bushing 20 into which the mounting pin 43 is inserted.

The adapter 30 is provided as a quadrangular tubular member, and corner portions thereof may be rounded.

Also, the adapter 30 includes an outer flange 31 provided on a front end portion thereof outwardly and an inner flange 33 provided on the front end portion inwardly.

That is, the outer and inner flanges 31 and 33 are provided on the front end portion of the adapter 30, and the other end portion of the adapter 30 is inserted between the central hole of the vibration-proof bushing 20 and the mounting pin 43.

The adapter 30 supports the inside member 23 through the outer flange 32. Also, the adapter 30, in a state of being in contact with a front end portion of the mounting pin 43 through the inner flange 33, is fastened by a bolt.

Here, a screw hole 45 is formed at the center of the mounting pin 43. Thus, a fastening bolt B for fixing the adapter 30 is fastened to the screw hole 45 of the mounting pin 43 through the inner flange 33 of the adapter 30.

The adapter 30 configured as described above may be formed of plastic, like the mounting bracket 10.

Thus, the mounting device 1 for a cooling module of a vehicle according to an exemplary embodiment of the present invention connects both sides of the cooling module 40 to the FEM and is designed in an overlapping manner such that the vibration-proof bushing 20 is compressed to the mounting part 41 of the cooling module 40, when assembled, whereby generation of coupling due to tolerance may be prevented.

Also, since the mounting device 1 enhances vibration insulation performance and mounting performance of the cooling module 40 through the vibration-proof bushing 20, NVH performance of a vehicle may be enhanced.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting device for a cooling module of a vehicle, serving to install a cooling module of the vehicle to a front end module (FEM), the mounting device comprising:
a mounting bracket having a fastening portion provided in a lower portion thereof, an assembling portion provided in an upper portion thereof, and having a bushing installation opening provided therein;
a vibration-proof bushing having an inside member and an outside member connected by a plurality of bridges and mounted in the bushing installation opening; and
an adapter having flanges provided on inner and outer portions thereof, having an end portion inserted between a mounting pin formed in a mounting portion of the cooling module and a central opening of the vibration-proof bushing into which the mounting pin is inserted, and fixing the vibration-proof bushing to the mounting pin through the flanges.

2. The mounting device of claim 1, wherein a rib is provided on an inside circumferential surface of the bushing installation opening of the mounting bracket to set a position of the vibration-proof bushing.

3. The mounting device of claim 1, wherein the mounting bracket, in a state of being inserted into a fastening recess of the FEM, is fastened to the fastening recess of the FEM by a fastener through the assembling portion, to be mounted in the FEM.

4. The mounting device of claim 1, wherein a planar section is provided in a portion of the inside circumferential surface of the bushing installation opening.

5. The mounting device of claim 1, wherein
an outer circumferential surface of an outside member is bonded to the bushing installation opening,
the inside member is disposed on an inside of the outside member and connected to the outside member through the plurality of bridges, and
a first end portion of the inside member corresponding to the mounting portion protrudes in an axial direction, relative to the outside member.

6. The mounting device of claim 5, wherein when the adapter is fastened, the protruded first end portion of the inside member of the vibration-proof bushing is compressed to the mounting portion.

7. The mounting device of claim 1, wherein the adapter is provided as a quadrangular tubular member and includes an outer flange provided on the front end portion thereof outwardly and an inner flange provided on the front end portion inwardly.

8. The mounting device of claim 7, wherein the adapter supports the inside member through the outer flange and is fastened by a fastener, in a state of being in contact with a front end portion of the mounting pin through the inner flange.

9. The mounting device of claim 7, wherein corner portions of the adapter are rounded.

10. The mounting device of claim 1, wherein the mounting bracket and the adapter are formed of plastic.
